(19) United States
(12) Patent Application Publication
(10) Pub. No.: US 2004/0195854 A1
(43) Pub. Date: Oct. 7, 2004

(54) Motor vehicle having a number of seats

(76) Inventor: Alexander Streit, Mettmann (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/477,455

(22) PCT Filed: Mar. 2, 2002
(86) PCT No.: PCT/EP02/02272

(30) Foreign Application Priority Data
May 12, 2001 (DE) 10123179.2

(51) Int. Cl. B60N 2/00

(52) U.S. Cl. 296/1.07

(57) ABSTRACT

In the case of a motor vehicle having a number of seats arranged in a common passenger compartment, in particular having seats in two or more rows one behind another, the invention makes provision for the arrangement of a passenger compartment communication system, at least one seat or one group of seats being assigned a microphone and another seat or another group of seats being assigned a speaker which is operatively connected to said microphone. This permits a conversation between the occupants in an unrestricted manner even when they remain in their desired sitting positions and speak comparatively quietly.

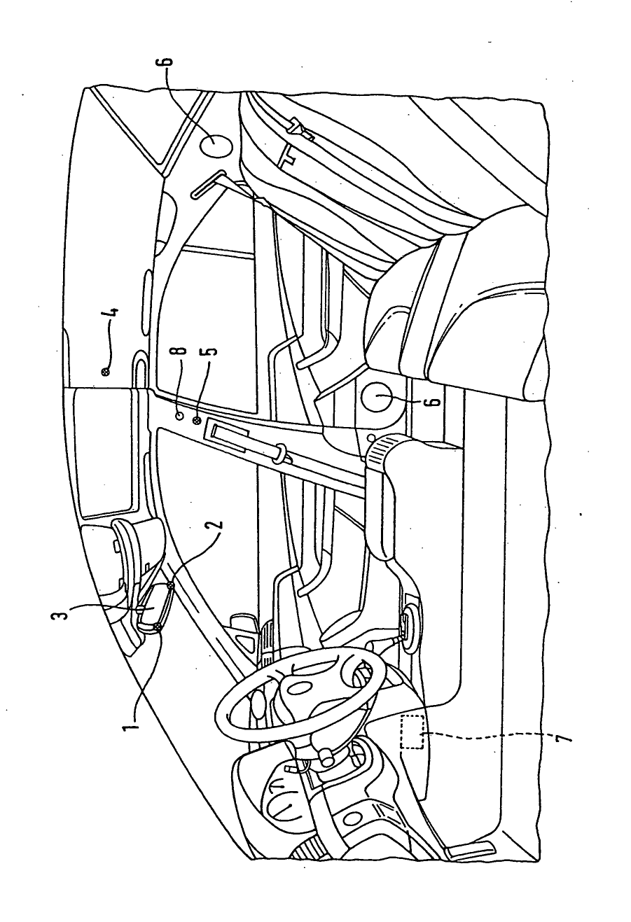

### BACKGROUND AND SUMMARY OF THE INVENTION

This application claims the priority of German patent document 101 23 179.2, filed May 12, 2001 (PCT International Application No. PCT/EP02/02272, filed Mar. 2, 2002), the disclosure of which is expressly incorporated by reference herein.

The invention relates to an acoustic passenger compartment communications system for a motor vehicle having a number of seats in a common passenger compartment, in particular having seats in two or more rows, one behind another.

Even in very comfortable passenger vehicles with good acoustic shielding of the passenger compartment from the exterior and driving and operating noises of the vehicle, conversation between the occupants may be acoustically difficult. This is especially true if the occupants are sitting in different rows of seats. In conversations between the occupants, it is therefore typical for an occupant who is at the rear or is sitting in the rear compartment to bend forward when talking to occupants such as the driver or front seat passenger, while the occupants who are sitting at the front often try to turn around.

Apart from the fact that the occupants take up uncomfortable sitting positions, the abovementioned behavior is undesirable for safety, because all of the occupants should assume a desired sitting position relative to modern safety systems, such as-airbags and seatbelts with automatic belt tighteners, in order to enable the safety systems to operate to optimum effect. Moreover, it is always extremely dangerous if the driver takes up a sitting position which is unfavorable for observing the events on the road.

To date, no solution has been provided for this problem. Rather, it is essentially merely known only to provide an intercom system in vehicles where the driver's cab is separated from the rest of the passenger compartment by means of a glass wall or the like, so that, when required, communication between the driver and the occupants separated from him by the partition is possible.

In addition, intercom systems are known which permit communication between the occupants and people outside the vehicle when the vehicle doors and windows are closed.

Japanese patent document JP 02312349 A describes a passenger compartment communication system in a motor vehicle, in which a microphone in the vicinity of the driver's seat picks up what the driver is saying and emits it at a speaker arranged in the vicinity of a rear seat. What a rear passenger is saying on a rear seat is picked up by a microphone arranged in the vicinity of the rear seat and emitted at a speaker in the vicinity of the driver's seat.

British patent document GB 2280332 A discloses a radio, cassette and CD system in a motor vehicle, which is used to realize a passenger compartment communication system.

One object of the present invention is to provide an improved acoustic system for communication between vehicle occupants.

This and other objects and advantages are achieved by the acoustic passenger compartment communications system according to the invention, which has at least one microphone assigned to a first seat or a first group of seats, and a speaker which is coupled to the microphone and is assigned to a second seat or a second group of seats.

The invention is based on the general concept of using electroacoustic systems to improve verbal communication between the vehicle occupants. Preferably the electroacoustic systems according to the invention are arranged in such a manner that, when the occupants take up desired sitting positions relative to safety systems, such as airbags and seatbelts with automatic belt tighteners, optimum communication capability is achieved. In addition to its direct intended use (to improve the acoustic communication capabilities), the passenger compartment communication system according to the invention fulfils a very important further purpose by increasing the safety of vehicle occupants, because the passenger compartment communication system allows them to converse in the desired sitting position, quietly and therefore in a readily comprehensible manner, without effort.

According to one particularly preferred embodiment of the invention, the passenger compartment communication system is integrated into a centrally controlled multifunctional system such as a radio or audio system, a telephone system, or acoustic warning systems. Thus, in this embodiment the speakers that are provided in, for example, the vehicle radio or audio system can also be used for the passenger compartment communication. Moreover, additional speakers which may be expedient for the passenger compartment communication system, can be used in order to improve the sound of the radio or audio system. In a corresponding manner, the microphones, which are present in any case for a hands-free telephone system, can also be used for the passenger compartment communication system. The additional microphones which may be desired for the passenger compartment communication system may, for their part, be used to expand the telephone system by making it possible, when necessary, to switch on a hands-free capability for different seats or occupants, or a “conference circuit” for all of the occupants to participate in the conversation.

If appropriate, connections for head-set and microphone units may also be distributed in the vehicle in order to permit individual occupants to use such units, in particular when telephoning. In principle, it is also possible to use devices of this type for communication in the passenger compartment.

Other objects, advantages and novel features of the present invention will become apparent from the following detailed description of the invention when considered in conjunction with the accompanying drawings.

### BRIEF DESCRIPTION OF THE DRAWINGS

The single FIGURE shows a side view of a passenger compartment of a passenger vehicle in which the front seats are not illustrated and only the seats of a rear seat bench are visible.

### DETAILED DESCRIPTION OF THE DRAWINGS

As shown in the FIGURE, to improve communication capability between vehicle occupants, the passenger compartment of a passenger vehicle is provided with a passenger compartment communication system. In particular, the system improves conversation between the driver or front seat passenger on the one hand, and the passengers on the rear seats, on the other hand. For this purpose, microphones and speakers which are coupled to each other are distributed in the passenger compartment.

In the illustrated example, respective microphones 1 and 2 are provided for the driver and front seat passenger on the interior rear view mirror 3 near to the windshield of the vehicle. For the passengers sitting at the rear, a common microphone 4 can be provided on the roof lining. Instead, it is of course also possible to arrange a microphone (not illustrated) on the rear side of the head restraints of the front seats (not illustrated), for each rear seat occupant, respectively. Moreover, it is also possible to provide microphones 5 on the B-pillars of the body for the passengers sitting at the rear.

The abovementioned microphones interact with speakers 6. That is, the microphones 1 and 2 which are assigned to the driver and front seat passenger expediently interact only with those speakers 6 which are arranged directly adjacent to the rear seats or to the heads of the occupants sitting at the rear. The same applies conversely for those speakers 6 with which the microphones 4 and 5 of the occupants sitting at the rear preferably interact.

The passenger compartment communication system has a central controller 7 which is assigned to the abovementioned microphones and speakers and can be accommodated, for example, in or under the dashboard of the vehicle. This controller can be designed in such a manner that it can “recognize” from the microphone signals whether the particular microphone is being acted upon by the sound of speech or other noises. Only if it is being acted upon with the sound of speech (in particular, speech of a certain minimum intensity), is or are the speaker or speakers assigned to the particular microphone activated.

According to one particularly preferred embodiment of the invention, the passenger compartment communication system can be integrated in a multifunctional system with a radio, audio and telephone system. The controller 7 is then preferably designed as a central controller for this entire system.

In this case, the controller can operate according to predetermined or predeterminable priorities:

In the case of normal radio or audio operation, all of the speakers 6 which are present in the vehicle can be used to achieve optimum spatial sound distribution.

As soon as the central controller 7 determines that one of the microphones 1, 2, 4 and 5 assigned to the occupants is being acted upon by the sound of speech, the volume of the radio or audio system is automatically reduced, and the speaker or speakers assigned to the microphone acted upon by the sound of speech are activated, in order to make the contribution of the particular occupant more audible for the other passengers.

When a telephone connection is produced, the radio and audio systems can be automatically switched to mute. Moreover, a microphone which is adjacent to the particular telephone conversation participant can be switched on while the other microphones are off. In addition, speakers adjacent to the seat of the particular telephone conversation participant can be switched on exclusively or amplified, providing the telephone conversation participant with a hands-free possibility in the vehicle.

In this case, it is, in principle, also possible for a number of occupants or all of the occupants in the vehicle to be able to participate in a telephone conversation by a number of microphones and the speakers assigned to the particular seats correspondingly switching on or remaining on.

If appropriate, various connecting sockets 8 may be provided for a head-set and microphone unit which may be worn and used individually by an occupant, making it possible for him or her to conduct a telephone conversation while the other occupants continue their normal conversation or listen to a radio or audio program.

The connecting sockets 8 may be designed in such a manner that the central controller 7 can detect whether a head-set and microphone unit is or is not connected. For example, a signal transmitter may be assigned to the particular connecting socket 8 or the head-set and microphone unit may produce a signal after receiving a “calling signal” from the central controller 7. In this manner, the telephone system may be automatically connected when the head-set and microphone unit is plugged in, so that when there are telephone calls, the abovementioned unit is preferably effectively connected.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A passenger compartment communication system for a motor vehicle having a purality of seats distributed within a common passenger compartment, said communications system comprising:
at least one microphone assigned to a first seat or a first group of seats;
at least one speaker which is coupled to the microphone and is assigned to a second seat or a second group of seats; and,
a multifunctional system including a radio and audio system controlled by a central controller; wherein,
speakers provided for the passenger compartment communication system are also available for use for other audio systems;
the multifunctional system also includes a hands-free telephone system; and
the microphones of the telephone system are also used for the passenger compartment communication system.

2. The motor vehicle as claimed in claim 1, wherein a separate microphone or a separate speaker is assigned to each seat or each group of seats.

3. The motor vehicle as claimed in claim 1, wherein the at least one microphone or the at least one speaker operates directionally with maximum sensitivity and maximum sound level in the direction of desired sitting positions of the occupants.

4. The motor vehicle as claimed in claim 1, wherein at least one microphone or at least one speaker or speakers is arranged on a side of front-seat head restraints which faces in a rearward direction of the vehicle, for occupants sitting behind them.

5. The motor vehicle as claimed in claim 1, wherein connecting sockets are provided for a head-set and microphone unit.

6. A motor vehicle comprising:
a unitary passenger compartment;
at least first and second groups of seats distributed within said passenger compartment; and
at least first and second supplementary communication media for communication between vehicle occupants in said first and second groups of seats;
said first communication medium comprising a primary direct audible acoustic transmission of speech between said first and second groups of seats; and
said second communication medium comprising an electronic communications system which simultaneously transmits the same speech between said first and second group of seats, supplementing said primary acoustic transmission.

7. The motor vehicle according to claim 6, wherein said electronic communications system comprises:
at least one microphone situated adjacent occupants of said first group of seats;
at least one speaker situated adjacent occupants of said second group of seats.

8. The motor vehicle according to claim 7, further comprising:
a vehicle audio system; and
a controller which controls operation of said audio system and said electronic communications system, said controller being programmed to reduce an operating volume of said audio system when it determines that speech is received at said microphone.
